(19) United States
(12) Patent Application Publication
(10) Pub. No.: US 2020/0308430 A1
(43) Pub. Date: Oct. 1, 2020

(54) AQUEOUS INK JET COMPOSITION, METHOD FOR PRODUCING AQUEOUS INK JET COMPOSITION, AND METHOD FOR PRODUCING RECORDING

(71) Applicant: Seiko Epson Corporation, Tokyo (JP)

(72) Inventors: Soichi YAMAZAKI, Shiojiri (JP); Naoyuki TOYODA, Suwa (JP); Hiroaki KUMETA, Matsumoto (JP); Manabu TANIGUCHI, Shiojiri (JP); Shunsuke UCHIZONO, Shiojiri (JP)

(21) Appl. No.: 16/830,369

(22) Filed: Mar. 26, 2020

(30) Foreign Application Priority Data
Mar. 27, 2019 (JP) 2019-060192

(51) Int. Cl. C09D 11/328; D06P 5/20; D06P 5/30; D06P 5/28

(52) U.S. Cl. CPC C09D 11/328; D06P 5/2077; C08L 67/00; D06P 5/006; D06P 5/30

(57) ABSTRACT

An aqueous ink jet composition contains water, a dye composed of at least one of sublimation dyes or at least one of disperse dyes, and polyester particles, which are particles made of at least one material including polyester. At least a subset of the polyester particles is stained with the dye.

The present application is based on, and claims priority from JP Application Serial Number 2019-060192, filed Mar. 27, 2019, the disclosure of which is hereby incorporated by reference herein in its entirety.

### BACKGROUND

### 1. Technical Field

The present disclosure relates to an aqueous ink jet composition, a method for producing an aqueous ink jet composition, and a method for producing a recording.

### 2. Related Art

In recent years, ink jet printing is becoming more widely used. Besides business and home printers, the technology is now applied to areas such as commercial printing and textile printing.

Against this background, certain types of inks currently used for ink jet printing contain a sublimation dye, i.e., a dye that can sublime, or a disperse dye.

Examples of printing processes in which such ink jet inks are used include direct printing, in which inks are attached to the recording medium to be dyed and then the dyes are fixed by heating, such as steaming, and thermal-transfer printing, in which dye inks are attached to an intermediate transfer medium and then heat is applied to transfer, by sublimation, the dyes from the intermediate transfer medium to the recording medium to be dyed (e.g., see JP-A-10-58638).

Producing strong colors in such settings requires a polyester surface on the recording medium, and this has limited the range of recording media that can be used. Increasing the heating temperature can improve the strength of the colors produced by the sublimation or disperse dyes, but depending on the type of recording medium, it can cause an unwanted discoloration, for example by causing the recording medium itself to melt or scorch.

### SUMMARY

The present disclosure was made to solve the above problem and can be implemented as in the following exemplary applications.

An aqueous ink jet composition according to an exemplary application of the present disclosure contains water, a dye composed of at least one of sublimation dyes or at least one of disperse dyes, and polyester particles, which are particles made of at least one material including polyester. At least a subset of the polyester particles is stained with the dye.

In an aqueous ink jet composition according to another exemplary application of the present disclosure, the amount of the dye in the aqueous ink jet composition is 0.1% by mass or more and 3.0% by mass or less.

In an aqueous ink jet composition according to another exemplary application of the present disclosure, the amount of the polyester in the aqueous ink jet composition is 5.0% by mass or more and 30% by mass or less.

In an aqueous ink jet composition according to another exemplary application of the present disclosure, 4.0≤X_{P}/X_{D}≤300, where X_{D} is the amount of the dye in the aqueous ink jet composition in % by mass, and X_{P} is the amount of the polyester in the aqueous ink jet composition in % by mass.

In an aqueous ink jet composition according to another exemplary application of the present disclosure, the average diameter of the polyester particles is 20 nm or more and 300 nm or less.

In an aqueous ink jet composition according to another exemplary application of the present disclosure, the dye is one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

In an aqueous ink jet composition according to another exemplary application of the present disclosure, the polyester is a self-emulsifying polyester.

A method according to an exemplary application of the present disclosure for producing an aqueous ink jet composition includes a composition preparation step, in which a composition is prepared that contains water, a dye composed of at least one of sublimation dyes or at least one of disperse dyes, and particles made of at least one material including polyester; and a heating step, in which the composition is heated.

In a method according to another exemplary application of the present disclosure for producing an aqueous ink jet composition, the temperature at which the composition is heated in the heating step is equal to or higher than Tg ° C., where Tg is the glass transition temperature of the polyester in ° C.

In a method according to another exemplary application of the present disclosure for producing an aqueous ink jet composition, the glass transition temperature of the polyester is 0° C. or more and 90° C. or less.

In a method according to another exemplary application of the present disclosure for producing an aqueous ink jet composition, the duration for which the composition is treated in the heating step is 1 minute or more and 7 days or less.

A method according to an exemplary application of the present disclosure for producing a recording includes an attachment step, in which an aqueous ink jet composition according to an exemplary application of the present disclosure is ejected by ink jet technology and attached to a recording medium; and a drying step, in which at least part of the water is removed from the aqueous ink jet composition attached to the recording medium.

A method according to another exemplary application of the present disclosure for producing a recording further includes a heating step, in which the recording medium with the aqueous ink jet composition attached thereto is heated, after the attachment step.

In a method according to another exemplary application of the present disclosure for producing a recording, the temperature at which the recording medium is heated in the heating step is 70° C. or more and 120° C. or less.

In a method according to another exemplary application of the present disclosure for producing a recording, the recording medium is a piece of fabric.

In a method according to another exemplary application of the present disclosure for producing a recording, the recording medium is made of at least one material including one or two or more selected from the group consisting of silk, wool, cellulose, acrylic fiber, polyurethane, and polyamide.

In a method according to another exemplary application of the present disclosure for producing a recording, the recording medium is made of materials including polyester and one or two or more selected from the group consisting of cotton, silk, polyamide, acrylic fiber, and polyurethane.

### DESCRIPTION OF EXEMPLARY EMBODIMENTS

The following describes preferred embodiments of the present disclosure in detail.

### 1. Aqueous Ink Jet Composition

First, an aqueous ink jet composition according to a preferred embodiment of the present disclosure is described.

The aqueous ink jet composition according to a preferred embodiment of the present disclosure contains water, a dye composed of at least one of sublimation dyes or at least one of disperse dyes, and polyester particles, which are particles made of at least one material including polyester. At least a subset of the polyester particles is stained with the dye.

By satisfying these conditions, the aqueous ink jet composition produces a strong color with a wide variety of recording media. Of particular note is that the dye is producing its color, or is present as single molecules, already in the aqueous ink jet composition. The dye therefore continues to produce a color well even after the composition is applied to a recording medium, and, importantly, a strong color is produced even when the recording medium is heated at a relatively low temperature for a relatively short period of time. Furthermore, since the composition produces a strong color even when the recording medium is heated at a relatively low temperature for a relatively short period of time, the composition is suitable even for use with recording media vulnerable to heat, such as those made of a material that melts or undergoes an unwanted discoloration upon heating at a relatively low temperature, providing more flexibility in the selection of the recording medium. By virtue of being capable of producing a strong color even when the recording medium is heated at a relatively low temperature for a relatively short period of time, the composition is also advantageous in terms of energy conservation and improving productivity in manufacturing recordings. Furthermore, as stated, at least a subset of the polyester particles is stained with the dye. When a recording is produced using the aqueous ink jet composition, this provides good prevention of events like an unwanted detachment of the dye from the recording, thereby ensuring stable retention of the dye by the recording. This means even when the recording is heated, for example by laundering or washing with warm water, heat drying in a dryer, or ironing, an unwanted diffusion of the dye from the recording is prevented effectively. The aqueous ink jet composition according to a preferred embodiment of the present disclosure, moreover, can be used in production processes for recordings in which no transfer is involved (described in detail later herein) and therefore is also favorable in terms of, for example, improving productivity in manufacturing recordings, reducing the cost of producing recordings, and resource conservation. Besides these, the composition is efficient in color production by the dye. Even when its dye content is low, therefore, the aqueous ink jet composition gives recordings produced therewith a sufficiently high color density. In addition, the dye print adheres firmly to the recording medium by virtue of the polyester.

In the aqueous ink jet composition according to a preferred embodiment of the present disclosure, the dye only needs to stain at least a subset of the polyester particles. This means, for example, part of the dye may be present without staining the polyester particles, i.e., as aggregates of multiple molecules. Even in such a case, attaching the aqueous ink jet composition to a recording medium and then heating the composition usually makes the dye produce a sufficiently strong color, including the part of the dye that is latent while in the aqueous ink jet composition. As a result, the finished print is superb in color strength. The inventors believe these great advantages owe to the following reason. That is, whereas heating a sublimation or disperse dye causes it to sublime or diffuse, heating polyester causes it to decompose. Polyester has ester linkages in its backbone, and when it is heated, some of the ester linkages break into carboxyl groups and hydroxyl groups. When the polyester is cooled, the carboxyl and hydroxyl groups recombine together. Heating polyester and at least one of sublimation or disperse dyes present close together and then cooling them therefore causes the sublimation or disperse dye to sublime or diffuse as single molecules and then keep its single-molecule state inside the polyester. As a result, the inventors believe, a strong color is produced. Furthermore, since the sublimation or disperse dye becomes single molecules even when its distance of travel is short compared with that in the known transfer by sublimation, the color produced is sufficiently strong even with a relatively short heating at a relatively low temperature. These great advantages accrue whenever the dye coexists with polyester particles in the same aqueous ink jet composition with some of the dye being latent, but become more significant when the dye is contained in the polyester particles, presumably because this configuration makes it more certain that the polyester and the dye will be close together. In the aqueous ink jet composition according to a preferred embodiment of the present disclosure, the percentage of dye present as aggregates of molecules, i.e., without staining the polyester particles, in all of the dye contained is preferably 10% by mass or less, more preferably 5% by mass or less, even more preferably 1% by mass or less.

When the above conditions are not satisfied, the results are unsatisfactory.

For example, with a polyester-free aqueous ink jet composition, it would be difficult to increase the percentage of single molecules in all molecules of the sublimation or disperse dye sufficiently high except with a recording medium having a polyester surface. The color strength would therefore be unsatisfactory.

With an aqueous ink jet composition that contains polyester but not with the polyester stained with the dye, too, it would be difficult to increase the percentage of single molecules in all molecules of the sublimation or disperse dye sufficiently high except with a recording medium having a polyester surface. The color strength would therefore be unsatisfactory.

It should be noted that an aqueous ink jet composition herein refers not only to ink itself ejected by ink jet technology but also to undiluted solution from which the ink is prepared. In other words, an aqueous ink jet composition according to a preferred embodiment of the present disclosure may be ejected by ink jet technology directly or may be ejected by ink jet technology after dilution or any such treatment. An aqueous ink jet composition herein, moreover, contains at least water as a major volatile liquid component. The proportion of water to all volatile liquid components in the aqueous ink jet composition is preferably 40% by mass or more, more preferably 50% by mass or more, even more preferably 70% by mass or more.

### 1-1 Polyester Particles

The aqueous ink jet composition according to a preferred embodiment of the present disclosure contains polyester particles, which are particles made of at least one material including polyester. At least a subset of the polyester particles is stained with a dye composed of at least one of sublimation dyes or at least one of disperse dyes.

The lower limit to the average diameter of the polyester particles is not critical, but preferably is 20 nm, more preferably 40 nm, even more preferably 60 nm. The upper limit to the average diameter of the polyester particles is not critical, but preferably is 300 nm, more preferably 250 nm, even more preferably 200 nm.

This makes it easier to prepare the aqueous ink jet composition. The stability of the polyester particles dispersed in the aqueous ink jet composition will also be bettered, and so will be the storage stability of the aqueous ink jet composition and the stability of the aqueous ink jet composition upon ink jet ejection.

An average diameter of particles herein refers to the volume-average diameter of the particles unless stated otherwise. The average diameter of particles can be determined by, for example, measurement using Microtrac UPA (Nikkiso).

### 1-1-1 Specific Dye

The aqueous ink jet composition according to a preferred embodiment of the present disclosure contains a dye composed of at least one of sublimation dyes or at least one of disperse dyes. A dye composed of at least one of sublimation dyes or at least one of disperse dyes may hereinafter be collectively referred to as “specific dyes.” Also at least a subset of the polyester particles as a component of the aqueous ink jet composition is stained with the specific dye.

In general, specific dyes produce strong colors when used with polyester. However, when used with other types of recording media, such as those made of materials like wool, cellulose, cotton, silk, polyester, polyamide, acrylic fiber, and polyurethane, specific dyes only produce weaker colors.

Examples of sublimation or disperse dyes include C.I. Disperse Yellow 1, 3, 4, 5, 7, 9, 13, 23, 24, 30, 33, 34, 42, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232; C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142; C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364; C.I. Disperse Violet 1, 4, 8, 23, 26, 27, 28, 31, 33, 35, 36, 38, 40, 43, 46, 48, 50, 51, 52, 56, 57, 59, 61, 63, 69, and 77; C.I. Disperse Green 9; C.I. Disperse Brown 1, 2, 4, 9, 13, and 19; C.I. Disperse Blue 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; C.I. Disperse Black 1, 3, 10, and 24.

Examples of sublimation or disperse fluorescent dyes include C.I. Disperse Red 364, C.I. Disperse Red 362, C.I. Vat Red 41, C.I. Disperse Yellow 232, C.I. Disperse Yellow 184, C.I. Disperse Yellow 82, and C.I. Disperse Yellow 43.

The specific dye may be one such sublimation or disperse dye or may be a combination of two or more.

It is particularly preferred that the specific dye be one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

These dyes are of poor color strength when not present as single molecules. In the related art, therefore, it has been difficult to produce a strongly colored recording with any such dye, particularly when the recording medium is made of material(s) other than polyester. This preferred embodiment of the present disclosure, however, provides the aforementioned great advantages even when the specific dye in the aqueous ink jet composition is any of these dyes. In other words, the advantages of this preferred embodiment of the present disclosure are more significant when the specific dye is one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

The lower limit to the specific dye content of the aqueous ink jet composition is preferably 0.1% by mass, more preferably 0.15% by mass, even more preferably 0.2% by mass. The upper limit to the specific dye content of the aqueous ink jet composition is preferably 7.5% by mass, more preferably 3.0% by mass, even more preferably 2.4% by mass.

This helps make the color strength and optical density of the print on a recording produced using the aqueous ink jet composition even better. Events like unwanted color irregularities in the recording, moreover, will be prevented more effectively.

### 1-1-2 Polyester

The polyester particles as a component of the aqueous ink jet composition according to a preferred embodiment of the present disclosure are primarily polyester.

Usually, the polyester is the most abundant component of the polyester particles. The lower limit to the polyester content of the polyester particles is not critical, but preferably is 80% by mass, more preferably 90% by mass, even more preferably 96% by mass. The upper limit to the polyester content of the polyester particles is not critical, but preferably is 99.5% by mass, more preferably 99% by mass, more preferably 98.5% by mass.

The polyester can be, for example, polyethylene terephthalate, polybutylene terephthalate, polytrimethylene terephthalate, polyethylene naphthalate, or polybutylene naphthalate.

The polyester can be any polymer material that has the ester linkage in its backbone. Thus, the polyester may be, for example, a modified polyester.

Preferably, the polyester as a component of the polyester particles is a self-emulsifying polyester.

This helps better, for example, the stability of the polyester particles dispersed in the aqueous ink jet composition and the stability of the composition upon ink jet ejection. Of particular note is that the stability of the polyester particles dispersed in the aqueous ink jet composition and the stability of the composition upon ink jet ejection will be good even when the composition is made using no surfactant or emulsifier or using some but only a small amount of surfactant or emulsifier. Reducing the amount of surfactant or emulsifier used or avoiding using a surfactant or emulsifier leads to more efficient staining of the polyester particles with the specific dye.

Examples of self-emulsifying polyesters include Toagosei's ARON MELT PES-1000 and ARON MELT PES-2000 polyesters, DIC's FINEDIC, and Toyobo's VYLONAL.

The lower limit to the acid value of the polyester is preferably 1.0 KOH mg/g, more preferably 1.5 KOH mg/g, even more preferably 2.0 KOH mg/g. The upper limit to the acid value of the polyester is preferably 15 KOH mg/g, more preferably 10 KOH mg/g, even more preferably 5.0 KOH mg/g.

This helps ensure the specific dye will produce an even stronger color with a wide variety of recording media.

The lower limit to the hydroxyl value of the polyester is preferably 1.0 KOH mg/g, more preferably 2.0 KOH mg/g, even more preferably 3.0 KOH mg/g. The upper limit to the hydroxyl value of the polyester is preferably 20 KOH mg/g, more preferably 15 KOH mg/g, even more preferably 10 KOH mg/g.

This helps ensure the specific dye will produce an even stronger color with a wide variety of recording media.

The lower limit to the number-average molecular weight of the polyester is preferably 3000, more preferably 6000, even more preferably 10000. The upper limit to the number-average molecular weight of the polyester is preferably 25000, more preferably 20000, even more preferably 18000.

This helps ensure the specific dye will produce an even stronger color with a wide variety of recording media.

The lower limit to the glass transition temperature of the polyester is preferably 0° C., more preferably 25° C., even more preferably 40° C. The upper limit to the glass transition temperature of the polyester is preferably 90° C., more preferably 75° C., even more preferably 70° C.

This helps combine higher levels of fixation of the polyester particles to a recording medium and durability of a recording produced using the aqueous ink jet composition. The polyester particles, moreover, will be stained better in production methods like that described in detail later herein.

The lower limit to the polyester content of the aqueous ink jet composition is preferably 5.0% by mass, more preferably 10% by mass, even more preferably 15% by mass. The upper limit to the polyester content of the aqueous ink jet composition is preferably 30% by mass, more preferably 27% by mass, even more preferably 24% by mass.

This helps better the storage stability of the aqueous ink jet composition and the stability of the aqueous ink jet composition upon ink jet ejection. The fixation of the dye print on a recording produced using the aqueous ink jet composition and the durability of the recording, moreover, will be even better.

The lower limit to X_{P}/X_{D}, where X_{D} is the specific dye content of the aqueous ink jet composition (% by mass), and X_{P} is the polyester content of the aqueous ink jet composition (% by mass), is preferably 4.0, more preferably 10, even more preferably 30. The upper limit to X_{P}/X_{D} is preferably 300, more preferably 150, even more preferably 60.

This helps combine higher levels of color strength of the print formed using the aqueous ink jet composition, adhesion of the print to the recording medium of a recording, and durability of the recording.

### 1-1-3 Other Ingredients

The polyester particles as a component of the aqueous ink jet composition may contain ingredients other than those described above.

Examples of such ingredients include colorants other than specific dyes; resin materials other than polyesters; dispersants; emulsifiers; water and nonaqueous solvents as described below; surfactants; penetrants, such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders, such as triethanolamine; pH-adjusting agents; chelating agents, such as ethylenediaminetetraacetate; antimolds/preservatives; and antirusts. Compounds having an isothiazolinone structure in the molecule, for example, are suitable for use as antimolds/preservatives.

The amount of ingredients other than the specific dye and polyester in the polyester particles is preferably 6% by mass or less, more preferably 5% by mass or less.

The aqueous ink jet composition only needs to contain polyester particles, which herein represent particles made of at least one material including polyester, stained with the dye. This means the aqueous ink jet composition may contain polyester particles not stained with a dye besides the stained particles.

When this is the case, the percentage of “stained polyester particles” in all polyester particles in the aqueous ink jet composition is preferably 50% by mass or more, more preferably 80% by mass or more, even more preferably 90% by mass or more.

This makes the aforementioned advantages of this preferred embodiment of the present disclosure more significant.

### 1-2 Water

Besides the polyester particles, the aqueous ink jet composition contains water. The water functions as a dispersion medium for the polyester particles.

The water may be, for example, reverse osmosis (RO) water, distilled water, ion exchange water, or any other type of purified water.

The lower limit to the water content of the aqueous ink jet composition is not critical, but preferably is 30% by mass, more preferably 35% by mass, even more preferably 40% by mass. The upper limit to the water content of the aqueous ink jet composition is not critical, but preferably is 85% by mass, more preferably 80% by mass, even more preferably 75% by mass.

This makes it more certain that the viscosity of the aqueous ink jet composition is adjusted to an appropriate level, thereby helping further improve the stability of the composition upon ink jet ejection.

### 1-3 Nonaqueous Solvents

Besides the polyester particles and water as a dispersion medium, the aqueous ink jet composition may contain a nonaqueous solvent.

This helps adjust the viscosity of the aqueous ink jet composition to an appropriate level and also helps improve the water retention of the aqueous ink jet composition. As a result, ink jet ejection of droplets of the composition will be more stable.

Examples of nonaqueous solvents that can be contained in the aqueous ink jet composition include glycerol, propylene glycol, and 2-pyrrolidone.

These solvents slow down the evaporation of the composition with their excellent water retention potential, thereby enabling more stable ejection of droplets of the composition.

The lower limit to the nonaqueous solvent content of the aqueous ink jet composition is not critical, but preferably is 0% by mass, more preferably 3% by mass, even more preferably 5% by mass. The upper limit to the nonaqueous solvent content of the aqueous ink jet composition is not critical, but preferably is 30% by mass, more preferably 25% by mass, even more preferably 20% by mass.

This makes the aforementioned effects of the presence of a nonaqueous solvent more significant.

### 1-4 Extra Ingredients

The aqueous ink jet composition may contain ingredients other than the polyester particles, water as a dispersion medium, and nonaqueous solvents. Such ingredients may hereinafter be referred to as extra ingredients.

Examples of extra ingredients include colorants other than specific dyes; surfactants; dispersants; emulsifiers; penetrants, such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders, such as triethanolamine; pH-adjusting agents; chelating agents, such as ethylenediaminetetraacetate; antimolds/preservatives; and antirusts. Compounds having an isothiazolinone structure in the molecule, for example, are suitable for use as antimolds/preservatives.

In particular, the presence of a surfactant in the aqueous ink jet composition is advantageous in achieving better image quality. The surfactant will help improve the wettability of the aqueous ink jet composition on a recording medium.

A surfactant in the aqueous ink jet composition can be selected from various surfactants, including anionic surfactants, cationic surfactants, and nonionic surfactants.

More specifically, examples of surfactants that can be contained in the aqueous ink jet composition include acetylene surfactants, silicone surfactants, and fluorosurfactants.

Another example of a possible extra ingredient is polyester that is not a component of the polyester particles. To be more specific, the aqueous ink jet composition may contain dissolved polyester.

When this is the case, the polyester content of the aqueous ink jet composition excluding the polyester in the polyester particles is preferably 3% by mass or less, more preferably 2% by mass or less, even more preferably 1% by mass or less.

Another example of a possible extra ingredient is a specific dye that is not a component of the polyester particles. To be more specific, the aqueous ink jet composition may contain a specific dye dispersed or dissolved outside the polyester particles.

When this is the case, the specific dye content of the aqueous ink jet composition excluding the specific dye in the polyester particles is preferably 0.03% by mass or less, more preferably 0.02% by mass or less, even more preferably 0.01% by mass or less.

The extra ingredient content of the aqueous ink jet composition is preferably 6% by mass or less, more preferably 5% by mass or less. When multiple extra ingredients are contained, it is preferred that the total amount satisfy this.

The lower limit to the surface tension at 25° C. of the aqueous ink jet composition is not critical, but preferably is 20 mN/m, more preferably 21 mN/m, even more preferably 23 mN/m. The upper limit to the surface tension at 25° C. of the aqueous ink jet composition is not critical, but preferably is 50 mN/m, more preferably 40 mN/m, even more preferably 30 mN/m.

This makes it less likely that, for example, the composition will clog the nozzles of an ink jet ejection apparatus used therewith, thereby further improving the stability of the aqueous ink jet composition upon ejection. The nozzles, moreover, will recover more quickly after capping even when clogged.

The surface tension can be that measured by the Wilhelmy method. The measurement of the surface tension can be through the use of a surface tensiometer, such as Kyowa Interface Science CBVP-7.

The lower limit to the viscosity at 25° C. of the aqueous ink jet composition is not critical, but preferably is 2 mPa·s, more preferably 3 mPa·s, even more preferably 4 mPa·s. The upper limit to the viscosity at 25° C. of the aqueous ink jet composition is not critical, but preferably is 30 mPa·s, more preferably 20 mPa·s, even more preferably 10 mPa·s.

This further improves the stability of the aqueous ink jet composition upon ejection.

The viscosity can be measured using a rheometer, such as Physica MCR-300. With such a rheometer, the shear rate is increased from 10 [s⁻¹] to 1000 [s⁻¹] at 25° C., and the viscosity is read at a shear rate of 200.

When the aqueous ink jet composition according to a preferred embodiment of the present disclosure is ink, the ink is usually packed in a container, such as a cartridge, bag, or tank, and used in that state with an ink jet recording apparatus. In other words, a recording apparatus according to a preferred embodiment of the present disclosure is one that includes an ink cartridge or other container in which ink as an aqueous ink jet composition according to a preferred embodiment has been packed.

### 2. Method for Producing an Aqueous Ink Jet Composition

The following describes a method according to a preferred embodiment of the present disclosure for producing an aqueous ink jet composition.

A method according to a preferred embodiment of the present disclosure for producing an aqueous ink jet composition includes a composition preparation step, in which a composition is prepared that contains water, at least one specific dye, and particles made of at least one material including polyester, and a heating step, in which the composition is heated.

This is an efficient way to produce an aqueous ink jet composition having the aforementioned excellent characteristics.

### 2-1 Composition Preparation Step

In the composition preparation step, a composition is prepared that contains water, at least one specific dye, and particles made of at least one material including polyester.

The composition can be prepared by, for example, mixing water, a specific dye, and a powder of polyester prepared separately.

Alternatively, the composition may be prepared by mixing an aqueous dispersion of polyester particles and a specific dye, optionally with water.

In the preparation of a composition in this step, moreover, nonaqueous solvents and extra ingredients as described above may be used.

The mixing in this step is performed preferably with stirring. This gives a composition in which its ingredients are mixed together more uniformly, thereby ensuring that uneven dyeing will be prevented better in the subsequent heating step.

The mixing of the ingredients in this step may be done at once or may be done in two or more stages.

### 2-2 Heating Step

In the heating step, the composition obtained in the composition preparation step is heated.

As a result of this, the particles made of at least one material including polyester are stained well with the specific dye.

The lower limit to the heating temperature in this step is preferably Tg ° C., more preferably (Tg+5) ° C., even more preferably (Tg+10) ° C., where Tg is the glass transition temperature (° C.) of the polyester. The upper limit to the heating temperature in this step is preferably 200° C., more preferably 150° C., even more preferably 100° C.

This leads to more efficient staining of the polyester particles, thereby helping make the manufacture of the aqueous ink jet composition more productive and make it more certain that a smaller percentage of the polyester particles will remain unstained. The aggregation of polyester particles, moreover, is prevented more effectively, making the finished aqueous ink jet composition more reliable.

The lower limit to the duration of treatment, i.e., the duration of heating, in this step is preferably 1 minute, more preferably 2 minutes, even more preferably 3 minutes. The upper limit to the duration of treatment, i.e., the duration of heating, in this step is preferably 7 days, more preferably 5 days, even more preferably 3 days.

This leads to more efficient staining of the polyester particles, thereby helping make the manufacture of the aqueous ink jet composition more productive and make it more certain that a smaller percentage of the polyester particles will remain unstained. The aggregation of polyester particles, moreover, is prevented more effectively, making the finished aqueous ink jet composition more reliable.

One or some of the ingredients of the aqueous ink jet composition may be added after the heating step or during the heating step. More specifically, one or some predetermined ingredients may be added after the heating step for purposes such as adjusting the chemical makeup of the aqueous ink jet composition and adjusting the viscosity, surface tension, and other physical characteristics of the composition. After the heating step, the composition may be subjected to concentration as a post-treatment.

The composition may be put under pressurized conditions after the composition preparation step. To be more specific, for example, the composition may be compressed. This leads to more efficient staining of the polyester particles.

### 3. Method for Producing a Recording

The following describes a method according to a preferred embodiment of the present disclosure for producing a recording.

A method according to a preferred embodiment of the present disclosure for producing a recording includes an attachment step, in which an aqueous ink jet composition according to a preferred embodiment of the present disclosure as described above is ejected by ink jet technology and attached to a recording medium; and a drying step, in which at least part of the water is removed from the aqueous ink jet composition attached to the recording medium.

The recording produced by this method is superior in color strength. Of particular note is that the color is strong with a wide variety of recording media.

### 3-1 Attachment Step

In the attachment step, an aqueous ink jet composition is ejected by ink jet technology and attached to a recording medium. The ink jet ejection of the aqueous ink jet composition can be through the use of a known ink jet recording apparatus. Examples of ejection techniques include piezoelectric ejection and the use of bubbles resulting from heating ink. Piezoelectric ejection is particularly preferred, for example because it is less detrimental to the quality of the aqueous ink jet composition.

In the attachment step, multiple aqueous ink jet compositions according to a preferred embodiment of the present disclosure may be used in combination. More specifically, multiple aqueous ink jet compositions containing different kinds of specific dyes, for example, may be used in combination.

In the attachment step, moreover, it is possible to use inks other than the aqueous ink jet composition(s) according to a preferred embodiment of the present disclosure.

### 3-2 Recording Medium

The recording medium can be made of any material or materials. Examples include resin materials, such as polyurethane, polyethylene, polypropylene, polyester, polyamide, and acrylic resin; paper, glass, metal, ceramic, leather, wood, and pottery clay and fiber of at least one of them; and natural, synthetic, or semisynthetic fibers, such as silk, animal-based fibers, cotton, hemp (including similar plant-based fibers), polyester, polyamide (nylon), acrylic fiber, polyurethane, cellulose, linters, viscose rayon, cuprammonium rayon, and cellulose acetate, and one or a combination of two or more selected from these can be used. The recording medium can have any three-dimensional shape, such as a sheet, spherical, or cubic shape.

It is particularly preferred that the recording medium be a piece of fabric.

Fabric dyeing is in great demand, for example in the manufacture of printed T-shirts. Printing using an iron or similar tool is widespread, and there is a strong need for dyeing of fabrics other than polyester fiber fabric. Given these, the advantages of this preferred embodiment of the present disclosure are more significant when the recording medium is a piece of fabric.

Preferably, the recording medium is made of at least one material including one or two or more selected from the group consisting of silk, wool, cellulose, acrylic fiber, polyurethane, and polyamide.

Despite a strong need for dyeing of them, these materials have been unsuitable for dyeing with sublimation or disperse dyes, for example because of their maximum withstand temperature. In this preferred embodiment of the present disclosure, a good recording can be produced even with a recording medium made with any of these materials. Given these, the advantages of this preferred embodiment of the present disclosure are more significant when the recording medium is made of at least one material including one or two or more selected from the group consisting of silk, wool, cellulose, acrylic fiber, polyurethane, and polyamide.

Fibers used in fabrics include hemp and animal-based fibers (e.g., wool). Being shaggy, hemp and animal-based fibers tend to interfere with ink ejection from nozzles by touching the ink jet head. Even if all nozzles successfully eject the ink, the ink does not adhere firmly because of many microscopic pores and irregularities present in the fabric. Hemp and animal-based fibers are therefore not appropriate for ink jet printing. Cotton, silk, polyester, polyamide, acrylic fiber, and polyurethane, which are not shaggy, are suitable for ink jet printing.

It is therefore preferred that the recording medium be made of at least one material including one or two or more selected from the group consisting of cotton, silk, polyester, polyamide, acrylic fiber, and polyurethane.

Certain recording media may be made of a mixture of polyester and any of these materials, i.e., made of materials including polyester and one or two or more selected from the group consisting of cotton, silk, polyamide, acrylic fiber, and polyurethane. With such a recording medium, known processes of dyeing with sublimation or disperse dye(s) have failed to dye the fiber(s) other than polyester, i.e., have tended to result in uneven dyeing. In this preferred embodiment of the present disclosure, even such a mixture dyes sufficiently well. The advantages of this preferred embodiment of the present disclosure are therefore more significant when the recording medium is such a mixture.

Even polyester alone, moreover, dyes better in this preferred embodiment of the present disclosure than in known processes of dyeing with sublimation or disperse dye(s) by virtue of highly efficient color production.

In the related art, a problem is that it is difficult to ensure sufficiently high color strength of the dye print and sufficiently firm adhesion between the recording medium and the dye print, and this problem looms larger when the recording medium is a piece of paper, glass, ceramic, metal, wood, or resin film or any other dense resin material, especially when the recording medium is a piece of glass. In this preferred embodiment of the present disclosure, the color strength of the dye print is sufficiently high, and the adhesion between the recording medium and the dye print is sufficiently firm even with any such recording medium. The advantages of the preferred embodiment of the present disclosure are therefore more significant when the recording medium is a piece of paper, glass, ceramic, metal, wood, or resin film or any other dense resin material.

### 3-3 Drying Step

Then at least some water is removed from the aqueous ink jet composition attached to the recording medium. As a result of this, the specific dye is fixed to the recording medium together with the polyester and any other remaining ingredient, giving a recording with the specific dye producing its color well.

Examples of drying treatments that can be performed in the drying step include air drying, air blowing, heating, and vacuum drying. One or a combination of two or more selected from these can be conducted.

At the end of the drying step, the water content of the print formed by the aqueous ink jet composition is preferably equal to or less than 5% by mass, more preferably equal to or less than 3% by mass, even more preferably equal to or less than 1% by mass.

This helps make the adhesion of the print to the recording medium on a recording even firmer.

### 3-4 Heating Step

The method may include a heating step, in which the recording medium with the aqueous ink jet composition attached thereto is heated, after the attachment step.

This helps make the adhesion of the print formed using the aqueous ink jet composition to the recording medium even firmer and make the recording further durable. The water content of the print formed using the aqueous ink jet composition, moreover, will be lower, making the finished recording more reliable. Furthermore, even when part of the specific dye in the aqueous ink jet composition is latent, this step makes this part of the specific dye produce its color efficiently. As a result, the color strength of the recording will be even stronger.

The heating step can be performed at any time after the attachment step. For example, it may be performed before the drying step, may be performed after the drying step, or may be part of the drying step.

The lower limit to the heating temperature in this step is not critical, but preferably is 70° C., more preferably 75° C., even more preferably 80° C. The upper limit to the heating temperature in this step is not critical, but preferably is 120° C., more preferably 115° C., even more preferably 110° C.

This makes the aforementioned effects more significant. The amount of energy required to produce the recording, moreover, will be further reduced, thereby helping further improve productivity in manufacturing recordings. Moreover, even recording media relatively vulnerable to heat are suitable for use, providing further flexibility in the selection of the recording medium. Furthermore, even when the produced recording is heated, for example by laundering or washing with warm water, heat drying in a dryer, or ironing, events like a unwanted discoloration and a change in optical density are well prevented.

The duration of heating in this step may vary with the heating temperature, but the lower limit to the duration of heating in this step is preferably 0.2 seconds, more preferably 1 second, even more preferably 5 seconds. The upper limit to the duration of heating in this step is preferably 300 seconds, more preferably 60 seconds, even more preferably 30 seconds.

This makes the aforementioned effects more significant. The productivity in manufacturing recordings, moreover, will be further improved. Furthermore, even recording media relatively vulnerable to heat are suitable for use, providing further flexibility in the selection of the recording medium.

This step may be performed by heating the surface of the recording medium to which the aqueous ink jet composition has been attached with this surface spaced apart from the heater or may be performed by heating this surface with the recording medium with the aqueous ink jet composition attached thereto and the heater in close contact with each other. Preferably, this step is performed by heating the surface of the recording medium to which the aqueous ink jet composition has been attached with the recording medium and the heater in close contact with each other.

This makes the aforementioned effects more significant. The amount of energy required to produce the recording, moreover, will be further reduced, thereby helping further improve productivity in manufacturing recordings. Moreover, diffusion of the specific dye from the recording medium will be prevented more effectively.

It is to be understood that the foregoing is a description of preferred embodiments of the present disclosure, and no aspect of the present disclosure is limited to them.

For example, an aqueous ink jet composition according to a preferred embodiment of the present disclosure is to be ejected by ink jet technology, but its use is not limited to methods like that described above.

For example, the composition may be used in a method that includes extra operations besides the steps described above.

When this is the case, a pretreatment can be, for example, forming a coating layer on the recording medium.

An intermediate treatment can be, for example, preheating the recording medium.

A post-treatment can be, for example, washing the recording medium.

An aqueous ink jet composition according to a preferred embodiment of the present disclosure, furthermore, may be produced by any method and does not need be produced by the method described above. For example, an aqueous ink jet composition according to a preferred embodiment of the present disclosure may be produced using polyester particles that have been produced by a method that includes preparing a first composition that contains at least one specific dye, polyester, and an organic solvent; preparing an emulsion by mixing the first composition and a water-containing second composition together to induce phase inversion emulsification of the first composition; and removing at least part of the organic solvent from the emulsion. Such polyester particles contain specific dye(s) in a suitable fashion. By heating the polyester particles during or after their production, the polyester particles can be stained with the specific dye contained in the polyester particles. Alternatively, an aqueous ink jet composition according to a preferred embodiment of the present disclosure may be produced using particles that contain at least one specific dye and polyester and have been formed by emulsion polymerization. Another aqueous ink jet composition according to a preferred embodiment of the present disclosure may be produced using, for example, particles produced through wet milling, dry milling, or any other type of milling of a paste obtained by kneading a mixture containing at least one specific dye and polyester.

### EXAMPLES

The following describes specific examples of aspects of the present disclosure.

### 1. Preparation of Ink Jet Inks

### Example 1

First, C.I. Disperse Yellow 232 as a specific dye was mixed with MD-1480 (Toyobo) as an aqueous dispersion of a self-emulsifying polyester having a glass transition temperature of 20° C., glycerol, triethylene glycol monobutyl ether, triethanolamine, OLFINE E1010 (Nissin Chemical Industry) as a surfactant, and purified water according to predetermined proportions. The resulting mixture was slurried by stirring at 3000 rpm with a high-shear mixer (Silverson).

The resulting slurry was stirred using a bead mill (LMZ015, Ashizawa Finetech) with 0.5-mm glass beads under water-cooled conditions to disperse the materials therein.

After the glass beads were removed, the slurry was heated at 50° C. for 10 hours. This gave an ink jet ink as an aqueous ink jet composition containing dye-stained polyester particles.

The acid value of the polyester in the MD-1480 was 3 KOH mg/g. The hydroxyl value of the polyester was 6 KOH mg/g, and the number-average molecular weight of the polyester was 15×10³.

### Examples 2 to 9

An ink jet ink was produced as in Example 1 except that the specific dye and polyester were changed and the proportions of ingredients were adjusted according to the formula given in Table 1 and that the heating parameters were as in Table 1.

### Comparative Example 1

An ink jet ink was produced as in Example 1 except that no polyester was used, the specific dye was changed, and the proportions of ingredients were adjusted according to the formula given in Table 1 and that no heating was performed.

### Comparative Examples 2 and 3

An ink jet ink was produced as in Example 1 except that the specific dye and polyester were changed and the proportions of ingredients were adjusted according to the formula given in Table 1 and that the heating parameters were as in Table 1.

### Comparative Example 4

An ink jet ink was produced as in Example 6 except that the specific dye was replaced with C.I. Direct Blue 86 (not a specific dye) and the heating parameters were as in Table 1.

The makeup of the ink jet inks of Examples and Comparative Examples is summarized in Table 1. In the table, C.I. Disperse Yellow 232 is represented by “DY232,” C.I. Disperse Red 364 is represented by “DR364,” C.I. Direct Blue 86 is represented by “DB86,” polyester is represented by “PEs,” glycerol is represented by “Gly,” triethylene glycol monobutyl ether is represented by “TEGBE,” triethanolamine is represented by “TEA,” and OLFINE E1010 (Nissin Chemical Industry) is represented by “E1010.” The ink jet inks of all Examples had a surface tension of 25 mN/m or more and 35 mN/m or less. The surface tension was measured by the Wilhelmy method at 25° C. using a surface tensiometer (Kyowa Interface Science CBVP-7). The ink jet inks of all Examples had a viscosity of 4 mPa·s or more and 10 mPa·s or less. The viscosity was measured using MCR-300 rheometer (Physica). With this rheometer, the shear rate was increased from 10 [s⁻¹] to 1000 [s⁻¹] at 25° C., and the viscosity was read at a shear rate of 200. The average diameter of the particles containing specific dye(s) and polyester in the ink jet ink was 20 nm or more and 300 nm or less in all Examples. For the ink jet inks of all Examples, the percentage of “stained polyester particles” to all polyester particles in the aqueous ink jet composition was 90% by mass or more. When the inks of Examples were heated, moreover, the inks became more vivid in color than before heating. The inks of Comparative Examples 2 and 3, by contrast, did not change in color or vividness of color when heated.

TABLE 1
Table 1

| | | | | PEs | | | | |
|---|---|---|---|---|---|---|---|---|
| | | | General | PEs with | PEs with | PEs with | | |
| | Specific dye(s) | | dye | a Tg of | a Tg of | a Tg of | | |
| | DY232 | DR364 | DB86 | 20° C. | 61° C. | 77° C. | Gly | TEGBE |
| | Amount | Amount | Amount | Amount | Amount | Amount | Amount | Amount |
| | [% by | [% by | [% by | [% by | [% by | [% by | [% by | [% by |
| | mass] | mass] | mass] | mass] | mass] | mass] | mass] | mass] |
| Example 1 | 0.4 | 0 | 0 | 20 | 0 | 0 | 10 | 3 |
| Example 2 | 0 | 0.4 | 0 | 0 | 20 | 0 | 10 | 3 |
| Example 3 | 1 | 0 | 0 | 0 | 0 | 20 | 10 | 3 |
| Example 4 | 0.6 | 0 | 0 | 0 | 20 | 0 | 10 | 3 |
| Example 5 | 0 | 0.6 | 0 | 0 | 0 | 20 | 10 | 3 |
| Example 6 | 0.6 | 0 | 0 | 20 | 0 | 0 | 10 | 3 |
| Example 7 | 0 | 0.2 | 0 | 20 | 0 | 0 | 10 | 3 |
| Example 8 | 0.6 | 0 | 0 | 0 | 20 | 0 | 10 | 3 |
| Example 9 | 0.2 | 0.2 | 0 | 0 | 20 | 0 | 10 | 3 |
| Comparative | 0 | 0.6 | 0 | 0 | 0 | 0 | 10 | 3 |
| Example 1 | | | | | | | | |
| Comparative | 0 | 0.6 | 0 | 0 | 20 | 0 | 10 | 3 |
| Example 2 | | | | | | | | |
| Comparative | 0.6 | 0 | 0 | 0 | 0 | 20 | 10 | 3 |
| Example 3 | | | | | | | | |
| Comparative | 0 | 0 | 0.6 | 20 | 0 | 0 | 10 | 3 |
| Example 4 | | | | | | | | |

| | TEA | E1010 | Water | | | | |
|---|---|---|---|---|---|---|---|
| | Amount | Amount | Amount | Heating parameters | | | Polyester |
| | [% by | [% by | [% by | Temperature | | | particles |
| | mass] | mass] | mass] | [° C.] | Duration | | stained |
| Example 1 | 1 | 0.5 | 65.1 | 50 | 10 | hours | Yes |
| Example 2 | 1 | 0.5 | 65.1 | 70 | 10 | hours | Yes |
| Example 3 | 1 | 0.5 | 64.5 | 90 | 10 | hours | Yes |
| Example 4 | 1 | 0.5 | 64.9 | 90 | 5 | minutes | Yes |
| Example 5 | 1 | 0.5 | 64.9 | 70 | 5 | minutes | Yes |
| Example 6 | 1 | 0.5 | 64.9 | 50 | 5 | minutes | Yes |
| Example 7 | 1 | 0.5 | 65.3 | 50 | 200 | hours | Yes |
| Example 8 | 1 | 0.5 | 64.9 | 70 | 200 | hours | Yes |
| Example 9 | 1 | 0.5 | 65.1 | 80 | 3 | hours | Yes |
| Comparative | 1 | 0.5 | 84.9 | — | — | | No |
| Example 1 | | | | | | | |
| Comparative | 1 | 0.5 | 64.9 | 50 | 10 | hours | No |
| Example 2 | | | | | | | |
| Comparative | 1 | 0.5 | 64.9 | 70 | 300 | hours | No |
| Example 3 | | | | | | | |
| Comparative | 1 | 0.5 | 64.9 | 70 | 10 | hours | No |
| Example 4 | | | | | | | |

### 2. Testing

### 2-1 Dispersibility of the Polyester Particles

Each ink jet ink of Examples and Comparative Examples was filtered through Merck's SCWP04700 8-μm membrane filter using the pressure of a water aspirator. The volume of successfully filtered ink jet ink was determined, and the dispersibility of the polyester particles was graded according to the criteria below. Larger volumes of successfully filtered ink jet ink mean better dispersibility of the polyester particles. An ink was considered good if the grade was C or better.

A: The volume of successfully filtered ink jet ink is 1000 mL or more.

B: The volume of successfully filtered ink jet ink is 100 mL or more and less than 1000 mL.

C: The volume of successfully filtered ink jet ink is 10 mL or more and less than 100 mL.

D: The volume of successfully filtered ink jet ink is 3 mL or more and less than 10 mL.

E: The volume of successfully filtered ink jet ink is less than 3 mL.

### 2-2 Color Strength of the Ink Jet Ink

The ink jet inks of Examples and Comparative Examples were heated, and the color strength of each ink jet ink was graded according to the criteria below. An ink was considered good if the grade was B or better. This was a visual test of heated inks for whether they became vivid when heated. In the next test, Color Strength of a Recording, the color strength of the inks was examined in further detail.

A: A strong fluorescent color is observed.

B: A fluorescent color is observed, although weaker than A.

C: The color of the ink has changed, but without a fluorescent color.

E: No change compared with the ink before heating.

### 2-3 Color Strength of a Recording

Each ink jet ink of Examples and Comparative Examples was ejected from PX-M860F recording apparatus (Seiko Epson) to draw a predetermined pattern on a piece of cotton fabric as a recording medium.

Then the side of the recording medium onto which the ink jet ink had been attached was heated at 100° C. for 20 seconds using an iron as a heater, completing a recording.

The resulting recordings were graded for color strength. Specifically, in the production of each recording, chromaticity was measured between the attachment of ink jet ink and heating. The finished recording was also subjected to the measurement of chromaticity. The points of measurement were a point in the portion of the recording medium to which the ink jet ink had been attached and the same point of the finished recording, and the measuring instrument was i1 (X-rite). The results were used to determine the percentage increase after heating in saturation as measured in the L*a*b* color space (square root of (a*²+b*²)), and optical density (OD) was also determined at a point of the recording to which the ink jet ink had been attached. Then color strength was graded according to the criteria below. Greater percentage increases in saturation and higher ODs mean better color strength. A recording was considered good if the grade was C or better.

A: The percentage increase in saturation is 50% or more, and the OD is 0.5 or more.

B: The percentage increase in saturation is 30% or more and less than 50%, and the OD is 0.5 or more.

C: The percentage increase in saturation is 15% or more and less than 30%, and the OD is 0.5 or more.

D: The percentage increase in saturation is 0% or more and less than 15%, and the OD is 0.5 or more.

E: Saturation is lower than before heating, or the OD is less than 0.5.

Then the same color strength test was repeated with different recording media: a piece of polyester fiber fabric, a piece of mixed fabric of polyester fiber and cotton fiber, a piece of silk fabric, a piece of polyurethane fiber fabric, a piece of acrylic fiber fabric, and a piece of polyamide fiber fabric. In the test in which the recording medium was a piece of mixed fabric of polyester fiber and cotton fiber, the heating parameters were changed to 150° C. and 20 seconds.

### 2-4 Fixation

The recordings of Examples and Comparative Examples produced in Section 2-3 were washed with a laundry detergent (Lion TOP Clear Liquid) and warm water at 40° C. in a home washing machine (Toshiba Lifestyle Products & Services TW-Z9500L front-loader washing and drying machine) set to its standard mode. The percentage decrease in the OD of the dye print after washing was determined, and fixation was graded according to the criteria below. Smaller percentage decreases in OD mean better fixation of the dye print formed by the ink jet ink to the recording medium. A recording was considered good if the grade was C or better.

A: The percentage decrease in OD is less than 3%.

B: The percentage decrease in OD is 3% or more and less than 10%.

C: The percentage decrease in OD is 10% or more and less than 30%.

D: The percentage decrease in OD is 30% or more and less than 50%.

E: The percentage decrease in OD is 50% or more.

The results are summarized in Table 2.

TABLE 2
Table 2

| | Dispersibility | | Color strength of a recording | | | | | | |
|---|---|---|---|---|---|---|---|---|---|
| | of the | Color strength | | | Polyester- | | | | |
| | polyester | of the | Cotton | Polyester | cotton mixed | Silk | Polyurethane | Acrylic | Polyamide |
| | particles | inkjet ink | fabric | fiber fabric | fabric | fabric | fiber fabric | fiber fabric | fiber fabric |
| Example 1 | A | B | B | B | B | B | B | B | B |
| Example 2 | A | A | A | A | A | A | A | A | A |
| Example 3 | A | A | A | A | A | A | A | A | A |
| Example 4 | A | A | A | A | A | A | A | A | A |
| Example 5 | A | B | B | B | B | B | B | B | B |
| Example 6 | A | B | B | B | B | B | B | B | B |
| Example 7 | C | A | A | A | A | A | A | A | A |
| Example 8 | C | A | A | A | A | A | A | A | A |
| Example 9 | A | A | A | A | A | A | A | A | A |
| Comparative | A | E | E | E | E | E | E | E | E |
| Example 1 | | | | | | | | | |
| Comparative | E | E | E | E | E | E | E | E | E |
| Example 2 | | | | | | | | | |
| Comparative | A | E | E | E | E | E | E | E | E |
| Example 3 | | | | | | | | | |
| Comparative | E | E | E | E | E | E | E | E | E |
| Example 4 | | | | | | | | | |

| | Fixation | | | | | | |
|---|---|---|---|---|---|---|---|
| | | | Polyester- | | | | |
| | Cotton | Polyester | cotton mixed | Silk | Polyurethane | Acrylic | Polyamide |
| | fabric | fiber fabric | fabric | fabric | fiber fabric | fiber fabric | fiber fabric |
| Example 1 | A | A | A | A | A | A | A |
| Example 2 | A | A | A | A | A | A | A |
| Example 3 | B | B | B | B | B | B | B |
| Example 4 | A | A | A | A | A | A | A |
| Example 5 | B | B | B | B | B | B | B |
| Example 6 | A | A | A | A | A | A | A |
| Example 7 | A | A | A | A | A | A | A |
| Example 8 | A | A | A | A | A | A | A |
| Example 9 | A | A | A | A | A | A | A |
| Comparative | A | A | A | A | A | A | A |
| Example 1 | | | | | | | |
| Comparative | B | B | B | B | B | B | B |
| Example 2 | | | | | | | |
| Comparative | E | E | E | E | E | E | E |
| Example 3 | | | | | | | |
| Comparative | A | A | A | A | A | A | A |
| Example 4 | | | | | | | |

As is clear from Table 2, examples of aspects of the present disclosure achieved good results. In Comparative Examples, the results were unsatisfactory.

Another set of recordings were produced in the same way but with a sheet of cellulose paper as a recording medium and tested as in Sections 2-2, 2-3, and 2-4, and the results were the same. Aqueous ink jet compositions and recordings were produced in the same way but with C.I. Disperse Yellow 54, C.I. Disperse Red 60, C.I. Disperse Blue 360, C.I. Disperse Blue 359, C.I. Disperse Orange 25, or C.I. Disperse Orange 60 as a specific dye, and the results were the same. Aqueous ink jet compositions and recordings were produced in the same way but with varying amounts of polyester within the range of 5.0% by mass to 30% by mass, and the results were the same. Then recordings were produced as in Section 2-3 except that the recording medium was a piece of wool fabric or a piece of polyamide fiber fabric and that the recording medium with ink jet ink attached thereto was heated at 200° C. for 60 seconds. In this case, the recordings were not evaluable. With wool fabric, the recording medium scorched when heated. With polyamide fiber, the recording medium melted when heated.

What is claimed is:

1. An aqueous ink jet composition comprising:
water;
a dye composed of at least one of sublimation dyes or at least one of disperse dyes; and
polyester particles, which are particles made of at least one material including polyester, wherein
at least a subset of the polyester particles is stained with the dye.

2. The aqueous ink jet composition according to claim 1, wherein an amount of the dye in the aqueous ink jet composition is 0.1% by mass or more and 3.0% by mass or less.

3. The aqueous ink jet composition according to claim 1, wherein an amount of the polyester in the aqueous ink jet composition is 5.0% by mass or more and 30% by mass or less.

4. The aqueous ink jet composition according to claim 1, wherein 4.0≤X_{P}/X_{D}≤300, where X_{D} is an amount of the dye in the aqueous ink jet composition in % by mass, and X_{P} is an amount of the polyester in the aqueous ink jet composition in % by mass.

5. The aqueous ink jet composition according to claim 1, wherein an average diameter of the polyester particles is 20 nm or more and 300 nm or less.

6. The aqueous ink jet composition according to claim 1, wherein the dye is one or two or more selected from the group consisting of C.I. Disperse Yellow 54, C.I. Disperse Red 60, C.I. Disperse Blue 360, C.I. Disperse Blue 359, C.I. Disperse Orange 25, C.I. Disperse Orange 60, C.I. Disperse Red 364, and C.I. Disperse Yellow 232.

7. The aqueous ink jet composition according to claim 1, wherein the polyester is a self-emulsifying polyester.

8. A method for producing an aqueous ink jet composition, the method comprising:
a composition preparation step, in which a composition is prepared that contains water, a dye composed of at least one of sublimation dyes or at least one of disperse dyes, and particles made of at least one material including polyester; and
a heating step, in which the composition is heated.

9. The method according to claim 8 for producing an aqueous ink jet composition, wherein a temperature at which the composition is heated in the heating step is equal to or higher than Tg ° C., where Tg is a glass transition temperature of the polyester in ° C.

10. The method according to claim 8 for producing an aqueous ink jet composition, wherein a glass transition temperature of the polyester is 0° C. or more and 90° C. or less.

11. The method according to claim 8 for producing an aqueous ink jet composition, wherein a duration for which the composition is treated in the heating step is 1 minute or more and 7 days or less.

12. A method for producing a recording, the method comprising:
an attachment step, in which an aqueous ink jet composition according to claim 1 is ejected by ink jet technology and attached to a recording medium; and
a drying step, in which at least part of the water is removed from the aqueous ink jet composition attached to the recording medium.

13. The method according to claim 12 for producing a recording, the method further comprising a heating step, in which the recording medium with the aqueous ink jet composition attached thereto is heated, after the attachment step.

14. The method according to claim 13 for producing a recording, wherein a temperature at which the recording medium is heated in the heating step is 70° C. or more and 120° C. or less.

15. The method according to claim 12 for producing a recording, wherein the recording medium is a piece of fabric.

16. The method according to claim 12 for producing a recording, wherein the recording medium is made of at least one material including one or two or more selected from the group consisting of silk, wool, cellulose, acrylic fiber, polyurethane, and polyamide.

17. The method according to claim 12 for producing a recording, wherein the recording medium is made of materials including polyester and one or two or more selected from the group consisting of cotton, silk, polyamide, acrylic fiber, and polyurethane.
